(19) United States
(12) Patent Application Publication
(10) Pub. No.: US 2013/0026148 A1
(43) Pub. Date: Jan. 31, 2013

(54) WELDING APPARATUS AND WELDING METHOD

(71) Applicants: Kazuo AOYAMA, Tokyo (JP); Tatsuya OODAKE, Zushi-shi (JP); Shinsaku SATO, Fujisawa-shi (JP); Mitsuo IWAKAWA, Yokohama-shi (JP)

(72) Inventors: Kazuo AOYAMA, Tokyo (JP); Tatsuya OODAKE, Zushi-shi (JP); Shinsaku SATO, Fujisawa-shi (JP); Mitsuo IWAKAWA, Yokohama-shi (JP)

(21) Appl. No.: 13/564,867

(22) Filed: Aug. 2, 2012

Related U.S. Application Data
(63) Continuation of application No. PCT/JP2011/000922, filed on Feb. 18, 2011.

(30) Foreign Application Priority Data
Feb. 18, 2010 (JP) 2010-033769

(51) Int. Cl. B23K 9/12

(52) U.S. Cl. 219/124.33; 901/42; 901/2; 901/46

(57) ABSTRACT

A welding apparatus of an embodiment includes: a welding torch and a shape sensor attached to a welding robot; a shape data extraction unit extracting, from measured data measured by the shape sensor, shape data representing an outline of an object to be welded; a transformation data calculation unit calculating, based on a position and a posture of the shape sensor, coordinate transformation data for correcting the shape data; a shape data correction unit correcting the shape data based on the coordinate transformation data; an angle calculation unit calculating, based on the corrected shape data, an inclination angle of a groove of the object to be welded; and a welding position and posture determination unit determining, based on the inclination angle of the groove, a position and a posture of the welding torch.

### CROSS-REFERENCE TO RELATED APPLICATIONS

This application is a continuation of prior International Application No. PCT/JP2011/000922 filed on Feb. 18, 2011, which is based upon and claims the benefit of priority from Japanese Patent Application No. 2010-033769 filed on Feb. 18, 2010; the entire contents of all of which are incorporated herein by reference.

### FIELD

Embodiments described herein relate generally to a welding apparatus and a welding method using a welding robot.

### BACKGROUND

In a large and complicated structure such as a hydraulic turbine runner of a hydraulic power unit, a member thereof uses a thick plate, so that for joining mutual members, multilayer build-up welding is employed. However, a welding operation of the members is not always easy, and depending on a material and a structure of the member, it becomes difficult to perform the welding operation. For example, when members with high crack sensitivity are welded, pre-heat treatment is conducted to prevent a crack of a welded portion, and the welding is performed in a state in which a base material is in a predetermined temperature range. For this reason, a worker who performs the welding is forced to perform the operation under a high temperature environment. Further, in a complicated structure in which mutual members are intricately disposed, a welding operation at narrow portion is conducted. For this reason, the worker is required to have a lot of laborious works such that the worker has to continuously take a posture with poor workability.

Accordingly, there has been proposed a welding apparatus using a rail. This welding apparatus includes a rail placed on an object to be welded along a weld line, a multi-joint robot that travels on the rail, and a sensor that measures a weld bead shape. Based on the weld bead shape measured by this sensor, a welding target position is corrected. As a result of this, it becomes possible to perform high-quality automatic welding. Further, there has been proposed a method of correcting, in multilayer build-up welding, a welding speed, a target position and a torch posture, by measuring a groove and a weld bead shape.

However, in the welding apparatus described in Patent Document 1, tremendous amounts of money and labor are required for manufacturing and attaching the rail corresponding to the object to be welded having a three-dimensional curved surface such as a hydraulic turbine runner. Further, in the object to be welded with a lot of narrow portions such as the hydraulic turbine runner, there is a limitation in the disposition of the sensor that measures the weld bead shape, so that a distortion is easily generated in shape data. Specifically, in order to avoid an interference between the sensor and the like and the object to be welded, it is required to dispose the sensor and the like at a position rotated and inclined with respect to a vertical plane of the weld line, resulting in that the distortion is generated in the measured shape data. In this case, an error is included in the correction of the welding speed and the like, based on the measured result of the shape of the weld bead.

### BRIEF DESCRIPTION OF THE DRAWINGS

FIG. 1 is a diagram illustrating a configuration of a welding apparatus of an embodiment.

FIG. 2 is a diagram illustrating a flow of a welding method of an embodiment.

FIG. 3 is a diagram illustrating a positional relation between the welding apparatus of the embodiment and a hydraulic turbine.

FIG. 4 is a diagram illustrating a state of a change in an inclination angle of a groove of the hydraulic turbine and welding.

FIG. 5 is a diagram illustrating a height change of a weld line of the hydraulic turbine.

FIG. 6 is a diagram illustrating a substantial part of the welding apparatus of the embodiment.

FIG. 7 is a diagram illustrating the welding method of the embodiment.

FIG. 8 is a diagram representing a coordinate transformation.

FIG. 9 is a diagram illustrating a shape (outline) represented by corrected shape data.

FIG. 10 is a diagram representing an example of conditional branch expression.

FIG. 11 is a diagram representing an example of conditional branch expression.

FIG. 12 is a diagram illustrating a configuration of a welding apparatus of an embodiment.

FIG. 13 is a diagram illustrating a flow of a welding method of an embodiment.

FIG. 14 is a diagram illustrating the welding method of the embodiment.

### DETAILED DESCRIPTION

A welding apparatus of an embodiment, includes: a welding torch and a shape sensor attached to a welding robot; a shape data extraction unit extracting, from measured data measured by the shape sensor, shape data representing an outline of an object to be welded; a transformation data calculation unit calculating, based on a position and a posture of the shape sensor, coordinate transformation data for correcting the shape data; a shape data correction unit correcting the shape data based on the coordinate transformation data; a point of change extraction unit extracting points of change in the corrected shape data; a groove surface extraction unit extracting a groove surface based on the extracted points of change; an angle calculation unit calculating an inclination angle of the extracted groove surface; and a welding position and posture determination unit determining, based on a width of a bead, a position of the welding torch and a posture of the welding torch with respect to the inclination angle of the groove.

A welding method of an embodiment, includes: controlling a position and a posture of a shape sensor with respect to an object to be welded, based on position and posture data; extracting shape data representing an outline of the object to be welded, from measured data measured by the shape sensor whose position and posture are controlled based on the position and posture data; calculating coordinate transformation data for correcting the shape data, based on the position and posture data; correcting the shape data using the coordinate transformation data; extracting a plurality of points of change in shape, from the corrected shape data; extracting a plurality of points of change in shape corresponding to end portions of a bead, from the corrected shape data; calculating a width of the bead and an inclination angle of a groove surface, based on the corrected shape data and the plurality of points of change in shape; determining welding conditions, and a position of the welding torch and a posture of the welding torch with respect to the inclination angle of the groove surface, based on the width of the bead; and performing welding based on the welding conditions, and the position and the posture of the welding torch.

Hereinafter, explanation will be made on embodiments while referring to the drawings. Note that in the respective drawings, similar components are denoted by the same reference numerals, and detailed explanation thereof will be appropriately omitted.

### First Embodiment

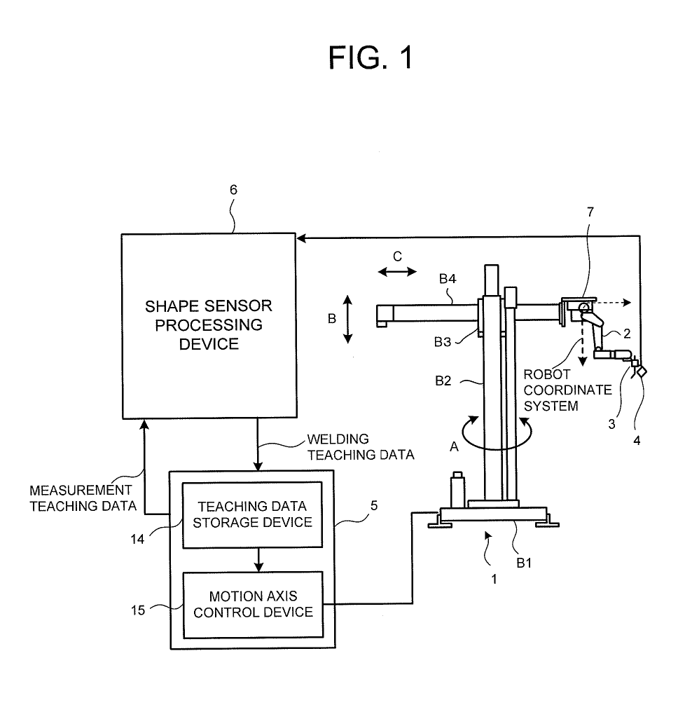

A welding apparatus of a first embodiment will be described by using FIG. 1. This welding apparatus includes a slider device 1, a shape sensor processing device 6 that receives data from the slider device 1, and a robot control device 5 that transmits/receives data to/from the shape sensor processing device 6. The robot control device 5 includes a teaching data storage device 14 and a motion axis control device 15. The teaching data storage device 14 transmits measurement teaching data to the shape sensor processing device 6. The motion axis control device 15 controls operations of the slider device 1 and a later-described welding robot 2.

The slider device 1 includes a pedestal B1, support posts B2, B3, and B4, and a base 7. The support post 332 can rotate with respect to the pedestal B1 as indicated by an arrow mark A with an axis in a longitudinal direction as a pivot. The support post B3 can move (linearly move) in a longitudinal direction (arrow mark B) with respect to the support post B2. The support post B4 can move (linearly move) in forward and backward directions (arrow mark C) with respect to the support post B3. The base 7 is attached to a front part of the support post B4. Specifically, the base 7 can rotate around an axis in the longitudinal direction, and can move in the longitudinal direction and in the forward and backward directions. On the base 7, the welding robot 2 is mounted.

The welding robot 2 has an arm capable of rotating around multiple axes with the use of multiple joints. For example, the arm can rotate around six axes with the use of six joints. In this case, first to sixth links (sub arms) are disposed on first to sixth joints, respectively. Specifically, the first joint, the first link, the second joint, the second link, . . . , the sixth joint, and the sixth link are sequentially disposed. The first joint is disposed on the base 7. Te j-th joint is disposed on a tip of the (j−1)-th link (1<j≦6). A tip of the sixth link corresponds to a tip of the arm.

To the tip of the arm, a welding torch 3 and a shape sensor 4 are attached so as to correspond to each other (a relative position (distance) between the welding torch 3 and the shape sensor 4 is fixed, for example). From the shape sensor 4, measured data is output to the shape sensor processing device 6. As will be described later, the shape sensor 4 can be configured by a combination of an irradiation device and an imaging device.

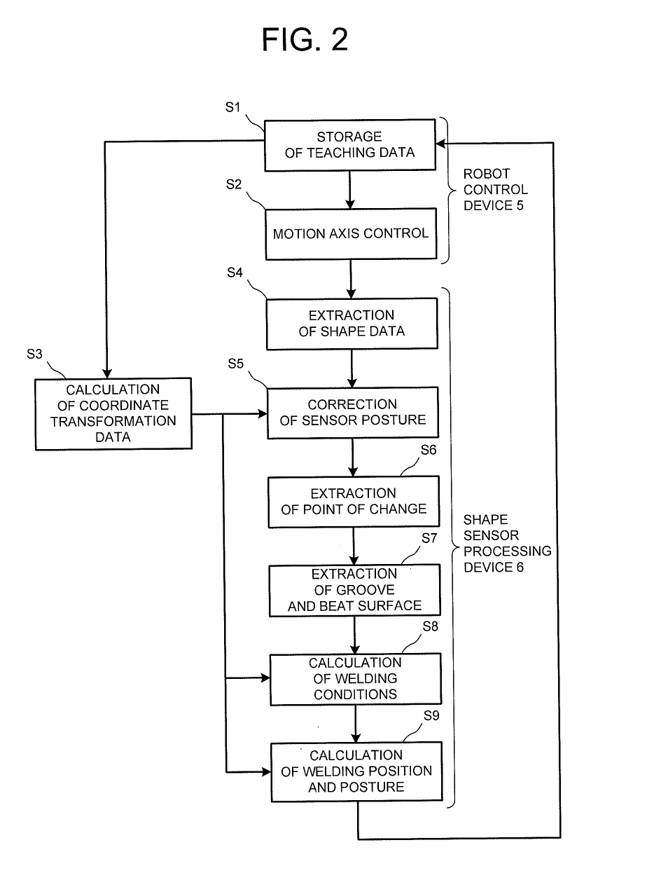

An operation of the welding apparatus will be described by using FIG. 2. The operation of the welding apparatus is divided into a processing process in the robot control device 5 (steps S1, S2), and a processing process in the shape sensor processing device 6 (steps S3 to S9).

In a teaching data storage process (step S1), teaching data is stored in the teaching data storage device 14. For example, a function of moving the welding torch 3 or the shape sensor 4 to a teaching point with the use of an operation device provided to the robot control device 5, and storing a position and a posture of the welding torch 3 or the shape sensor 4, is selected. As a result of this, the teaching data is input, and is stored in the teaching data storage device 14.

The teaching data is formed of an operation instruction including position and posture data representing the positions and the postures of the welding torch 3 and the shape sensor 4 attached to the tip of the arm of the welding robot 2, and welding conditions. The teaching data can be divided into welding teaching data used when performing welding by the welding torch 3, and measurement teaching data used when performing measurement by the shape sensor 4.

The position and posture data corresponds to a weld (planned) line (a line segment representing an axis of bead formed on an object to be welded). Specifically, the position of the welding torch 3 (correctly, a point at which the welding is performed by the welding torch 3) is located on the weld line. Further, generally, it is preferable to dispose the welding torch 3 on a vertical plane of the weld line and in a direction passing through a center of an inclination angle of a pair of groove surfaces (normal position and posture). Usually, the position and posture data is set by corresponding to such position and posture.

However, there is a case in which the normal position and posture cannot be selected due to the relation of interference between the welding apparatus and the object to be welded. In this case, the position and the posture of the welding torch 3 are changed so that the welding apparatus and the object to be welded do not interfere with each other. In this embodiment, the interference can be avoided by a person by operating the slider device 1 and the welding robot 2 using the operation device provided to the robot control device 5.

In like manner, the position and the posture of the shape sensor 4 also correspond to the weld planned line. It is assumed that the shape sensor 4 is configured by a combination of an irradiation device and an imaging device. In this case, it is preferable that light is irradiated from the irradiation device along the vertical plane of the weld line. For example, a later-described irradiation plane S0 preferably coincides with a vertical plane S1 of the weld line. Note that the position and the posture of the shape sensor 4 are appropriately changed so that the welding apparatus and the object to be welded do not interfere with each other.

As described above, the teaching data (the position and posture data) which prevents the interference between the welding apparatus and the object to be welded, is input in the teaching data storage process (step S1).

Different pieces of position and posture data can be used in each of the welding by the welding torch 3 and the measurement by the shape sensor 4 (at least the position and the posture of the welding torch 3, or those of the shape sensor 4 are different). However, it is also possible that the position and the posture of the welding torch 3 and those of the shape sensor 4 are made to be the same.

The position and posture data can be divided into base coordinates representing a mounting position of the welding robot 2 (base 7), and relative coordinates (robot coordinate system) representing a relative displacement of the welding torch 3 or the like from the base coordinates. The base coordinates and the relative coordinates are respectively used for controlling the operations of the slider device 1 and the welding robot 2.

In a motion axis control process (step S2), motion axes of the slider device 1 and the welding robot 2 are controlled, based on the teaching data (measurement teaching data) stored in the teaching data storage process (step S1). The operations of the slider device 1 and the welding robot 2 are controlled based on the base coordinates and the relative coordinates, respectively, in the teaching data. Specifically, the position and the posture of the shape sensor 4 are controlled based on the position and posture data. After performing the control, the measurement by the shape sensor 4 is conducted.

In a coordinate transformation data calculation process (step S3), coordinate transformation data (later-described transformation matrixes Cn, Cn′, Cn″, or the like) for correction of shape data is calculated based on the teaching data (measurement teaching data) output from the robot control device 5. The coordinate transformation data calculated in this process is used in step S5, step S8, and step S9. Note that the calculation of the coordinate transformation data will be described later in detail.

In a shape data extraction process (step S4), by performing denoising and binarizat ion on the measured data output from the shape sensor 4 in the motion axis control process (step S2), shape data representing an outline of an object to be welded is extracted. As will be described later, a distortion is generated in the shape data depending on the position and the posture of the shape sensor 4 with respect to the object to be welded.

In a sensor posture correction process (step S5), the shape data extracted in the shape data extraction process (step S4) is corrected by using the coordinate transformation data calculated in the coordinate transformation data calculation process (step S3). Specifically, the distortion in the shape data is reduced.

In a point of change extraction process (step S6), points of change in shape are extracted from the shape data corrected in the sensor posture correction process (step S5). This point of change corresponds to, for example, a boundary between an upper surface and a groove surface of the object to be welded, or a boundary between a weld bead and a groove surface (an end portion of the weld bead). Specifically, at boundaries among a plurality of surfaces (an upper surface, a groove surface, and a bead surface, for example), an angle of an outline of the surfaces drastically changes. For this reason, a point of change is extracted as a portion in which an absolute value of local gradient (differential amount) in the outline represented by the shape data is large. Note that details of this will be described later.

In a groove and bead surface extraction process (step S7), the end portions of the bead are extracted from the points of change extracted in the point of change extraction process (step S6). Further, the bead surface and the groove surface are specified. As already described, the point of change includes the end portion of the weld bead (the boundary between the weld bead and the groove surface). As will be described in a third embodiment, pieces of shape data before and after the previous welding (welding performed on a lower layer of a weld layer formed this time) are compared, and points with large variation in shape can be extracted as the end portions of the bead. The shape data between the two end portions of the weld bead corresponds to the bead surface. Further, the shape data on both sides of the two end portions corresponds to a pair of groove surfaces. Note that details of this will be described later.

In a welding condition calculation process (step S8), welding conditions, a welding target position (a position of the welding torch 3 when performing the welding), a welding torch posture (a posture (direction) of the welding torch 3 when performing the welding) are determined from a width of the bead and an inclination angle of the pair of groove surfaces specified in the groove and bead surface extraction process (step S7). The width of the bead corresponds to a distance between the two end portions of the weld bead.

In a welding position and posture calculation process (step S9), the welding target position and the welding torch posture calculated in the welding condition calculation process (step S8) are calculated as a position and a posture on the robot coordinate system. The calculated position data is stored as teaching data (welding teaching data) in the teaching data storage device 14. Based on this welding teaching data, the welding apparatus conducts the welding.

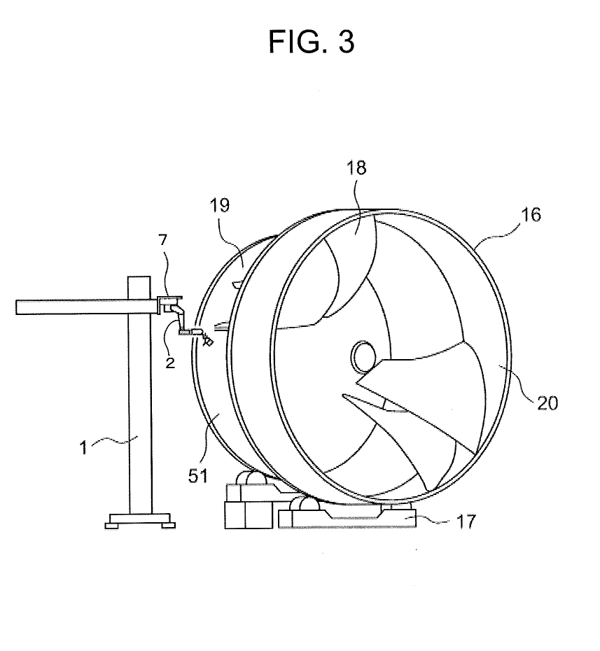

As an example, welding of a hydraulic turbine runner will be described. As illustrated in FIG. 3, a hydraulic turbine runner 16 is lifted in an upright state by a crane (not illustrated), and is placed on a turning roller 17. The welding apparatus configured by the slider device 1 and the welding robot 2 is placed on the side of an opening 51 of the hydraulic turbine runner 16.

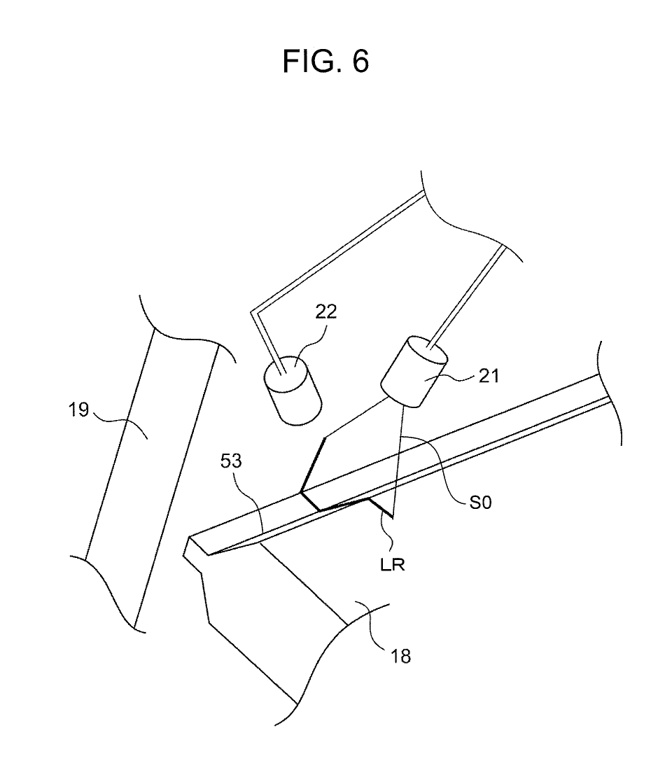

By rotating the turning roller 17, the hydraulic turbine runner 16 is rotated in conjunction with the turning roller 17. The rotation of the hydraulic turbine runner 16 is stopped at an angle at which a groove portion (a portion corresponding to a groove surface) 53 (refer to FIG. 6) of a blade 18 (a member to be an object to be welded) is positioned in front of the welding apparatus. Under that state, the slider device 1 and the welding robot 2 are operated by the motion axis control device 15 provided to the robot control device 5. The shape sensor 4 attached to the tip of the arm of the welding robot 2 measures a shape of the groove portion 53.

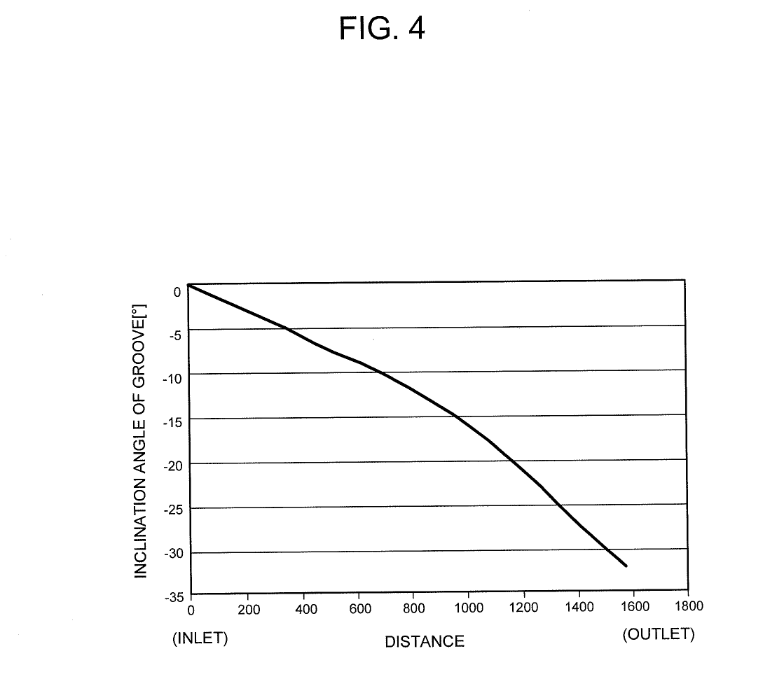

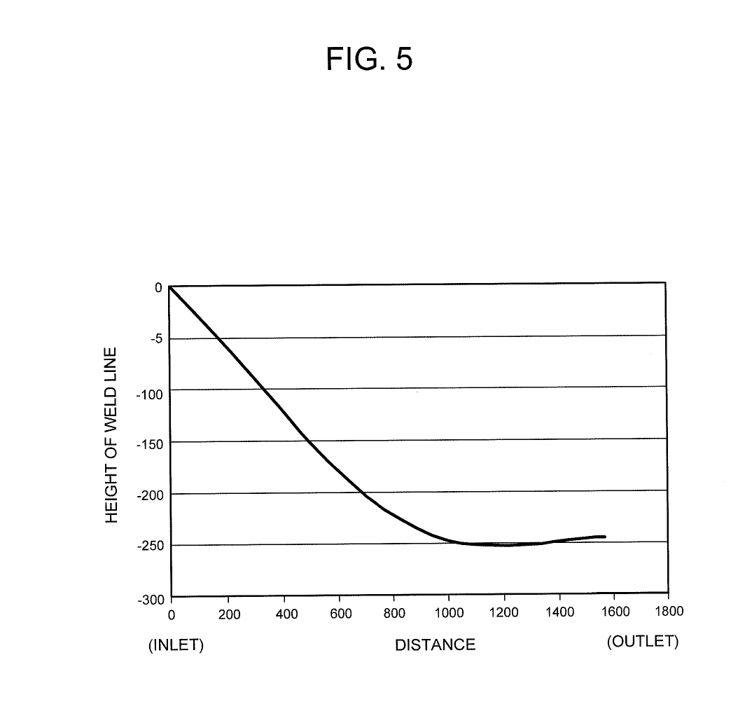

Each of the blade 18, a crown 19 and a band 20 being members of the hydraulic turbine runner 16 has a three-dimensional curved surface. FIG. 4 and FIG. 5 illustrate examples of an inclination angle of the groove of the blade 18 and a gradient of a weld line. A vertical axis in FIG. 4 represents the inclination angle of the groove. A horizontal axis in FIG. 4 represents a distance in a direction from an inlet (a portion located on an outer peripheral side of the hydraulic turbine runner 16 and through which water is taken in) toward an outlet (a portion located at a center of the hydraulic turbine runner 16 and through which water is discharged). Further, a vertical axis in FIG. 5 represents a height from a reference point. A horizontal axis in FIG. 5 represents a distance in a direction from the inlet toward the outlet. It can be understood that the inclination angle and the gradient of the weld line continuously change.

In the present embodiment, it is possible to perform welding on a three-dimensional curved surface and the like having a complicated shape. Hereinafter, explanation will be made on a case where a shape sensor 4 as illustrated in FIG. 6 is used, as an example. The shape sensor 4 is formed of a laser slit light irradiator 21 being an irradiation device and a CCD camera 22 being an imaging device.

The laser slit light irradiator 21 irradiates laser light in a slit form (slit light). The slit light traveling toward the blade 18 being the object to be welded is irradiated to a linear portion (irradiation line) LR intersecting an irradiation plane (a plane formed by the slit light) S0. The irradiation line LR has a shape corresponding to an outline of the object to be welded. An image of the irradiation line LR is taken as measured data by the CCD camera 22. As already described, in the shape data extraction process (step S4), a shape of the slit light (a shape of the irradiation line LR) is extracted, as shape data, from the measured data.

To be precise, the shape data is generated in the following manner. First, from an image obtained by the CCD camera 22 (measured data), pixels of slit light irradiated to the object to be welded (the irradiation line LR) are extracted. Further, based on a relative position and a relative posture (direction) between the light irradiator 21 and the CCD camera 22, positions of the extracted respective pixels (the irradiation line LR) are transformed into positions on the plane formed by the slit light irradiated from the light irradiator 21 (the irradiation plane S0). As a result of this, the shape data is generated.

When an accuracy of the shape data to be extracted is taken into consideration, the irradiation plane S0 is preferably vertical to a weld (planned) line. Specifically, the welding robot 2 is controlled to determine the position and the posture of the shape sensor 4, so that the irradiation plane S0 becomes vertical to the weld line.

As already described, there may be a case where the position and the posture of the shape sensor 4 are limited, and thus the irradiation plane S0 and the weld line cannot be vertical to each other. Specifically, depending on the position and the posture of the shape sensor 4, there is a possibility of interference (contact) among the members of the hydraulic turbine runner, and the welding torch 3 and the shape sensor 4. In this case, there is a need to change the posture of the shape sensor 4 to avoid the interference.

When the irradiation plane S0 and the weld line are not vertical to each other, the shape data extracted in the shape data extraction process (step S4) includes a distortion corresponding to an amount of change in the posture. For this reason, there is a need to correct the shape data. Here, the distortion corresponding to the amount of change in the posture means a deviation from the shape data when the irradiation plane S0 of the slit light is vertical to the weld line. Note that also when a shape sensor employing another detection method is used, a distortion is generally generated, and thus the correction becomes necessary.

For correcting the amount of change in the posture, a position and a direction of the irradiation plane S0 (data regarding the posture of the shape sensor 4 with respect to the vertical plane of the weld line) is required. Accordingly, the measurement teaching data (position and posture data) is transmitted to the shape sensor processing device 6 from the teaching data storage device 14.

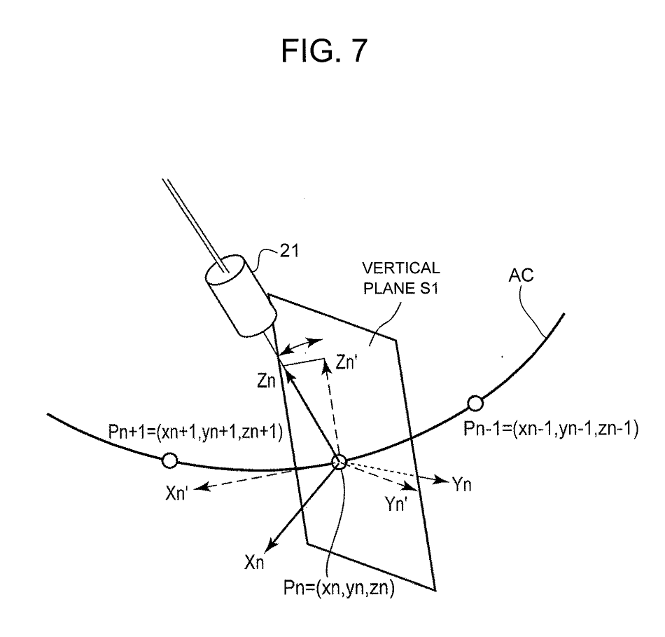

The correction of the amount of change in the posture will be described using FIG. 7. It is considered to correct shape data corresponding to a measurement teaching point (in this case, a point on the weld planned line) Pn. In the coordinate transformation data calculation process (step S3), an arc AC passing through three measurement teaching points Pn−1, Pn, and Pn+1 including the measurement teaching point Pn and measurement teaching points Pn−1 and Pn+1 before and behind the measurement teaching point Pn, is supposed to exist. A tangent vector Xn′ that is brought into contact with the arc AC at the teaching point Pn is determined. The tangent vector Xn′ represents a direction of weld line at the teaching point Pn.

Next, a vertical plane S1 of the weld line including the teaching point Pn and in which the vector Xn′ is set as a normal vector, is determined. From the position and posture data at the measurement teaching point of the measurement teaching data input from the above teaching data storage device 14, a vector Zn representing an axial direction of the laser slit light irradiator 21 of the shape sensor 4 is determined. A vector Zn′, being the vector Zn projected onto the above vertical plane, is determined.

A unit vector of the tangent vector Xn′ is set as N, and a projection matrix projected onto the plane S1 vertical to N is set as Pn. At this time, a relation as follows is satisfied.

Pn=I−N·N^{T}

Here, I is a unit matrix, and N^{T} is a transposed vector being a transposed unit vector N. From the above, Zn′ can be calculated through the following expression.

Zn′=Pn·Zn

A vector Yn′ orthogonal to the vectors Xn′ and Zn′ obtained as above, is determined.

Yn′=Zn′×Xn′ (Here, “x” represents a vector product.) A matrix (transformation matrix) Cn′ representing a coordinate system of the vertical plane S1 in which these vectors Xn′, Yn′ and Zn′ are set as coordinate axes, and the teaching point Pn is set as an origin of coordinates (seen from a robot coordinate system), is calculated.

Next, the calculation of the transformation matrix Cn will be described. As already described, the shape sensor 4 (and the welding torch 3) is (are) attached to the arm of the welding robot 2 having six joints, for example. Accordingly, the position and the posture (direction) of the shape sensor 4 are determined in accordance with motions of the six joints.

Here, relative position and posture of each of the tips of the first to the sixth links connected to the first to the sixth joints can be represented by a matrix Aᵢ. Specifically, a matrix Aᵢ represents a position and a posture of the tip of the first link with respect to the robot coordinates set as a reference. A matrix Aᵢ represents a position and a posture of the tip of the i-th link with respect to the tip of the (i−1)-th link set as a reference.

If it is configured as above, a matrix T₆ representing a position and a direction of the tip of the arm of the robot 2 (the shape sensor 4) (a position and a direction of the irradiation plane S0 (a position and a posture at the teaching point of the measurement teaching data)) can be represented by a product of matrixes A₁ to A₆, as described below.

T₆=A₁·A₂·A₃·A₄·A₅·A₆ Expression (1)

In the matrix Aᵢ, both of a translational component and a rotational component may be included. The translational component represents a component of coordinate transformation due to a translational movement of the tip of the i-th link with respect to the tip of the (i−1)-th link. The rotational component represents a component of coordinate transformation due to a rotational movement of the tip of the i-th link with respect to the tip of the (i−1)-th link.

The translational component corresponds to the position of the teaching point Pn. This can be obtained by solving a kinematic equation, when the measurement teaching data is stored by angles of respective joint axes. The translational component is calculated from the expression (1) corresponding to the teaching data at the teaching point Pn.

The rotational component will be described. Unit vectors of the vectors Xn′, Yn′, and Zn′ are set as N=[Nx, Ny, Nz, 0]^{T}, O=[Ox, Oy, Oz, 0]^{T}, and A=[Ax, Ay, Az, 0]^{T}, respectively. Further, a rotation around the Z axis is set as Ar, a rotation around the Y axis is set as Δp, and a rotation around the X axis is set as Δy (rotation of roll, pitch, and yaw).

It is known that the rotational transformation in this case can be represented as below.

Δr=a tan 2(Ny, Nx) and Δr=Δr+180°

Δp=a tan 2(−Nz, cos Δr·Nx−sin Δr·Ny)

Δy=a tan 2(sin Δr·A−cos Δr·Ay, −sin Δr·Ox+cos Δr·Oy)

A matrix (transformation matrix) Cn representing a coordinate system of the irradiation plane S0 in which the vectors Xn, Yn, and Zn are set as coordinate axes, and the teaching point Pn is set as an origin of coordinates (seen from the robot coordinate system), can be represented by an expression (2) similar to the expression (1).

Cn=A₁·A₂·A₃·A₄·A₅·A₆ Expression (2)

Note that the contents of the matrix Aᵢ are not always the same in the expressions (1) and (2) (the states of the arm of the welding robot 2 are different).

The transformation matrixes Cn′ and Cn calculated as above mean coordinate transformation data. The coordinate transformation data is used in the sensor posture correction process (step S5), the welding condition calculation process (step S8), and the welding position and posture calculation process (step S9).

In the sensor posture correction process (step S5), the shape data extracted in the shape data extraction process (step S4) is corrected. Specifically, from a position matrix Tn corresponding to a point on the shape data (point on the irradiation line LR), a position matrix Tn′ corresponding to the corrected shape data is calculated.

Concretely, the position matrix Tn′ is calculated through the following expression (3).

Tn′=Cn′⁻¹·Cn·Tn Expression (3)

Here, “Cn′⁻¹” represents an inverse matrix of the matrix Cn′.

Next, the meaning of the calculation of the position matrix Tn′ from the position matrix Tn through the expression (3) (coordinate transformation based on “Cn′⁻¹·Cn”) is described.

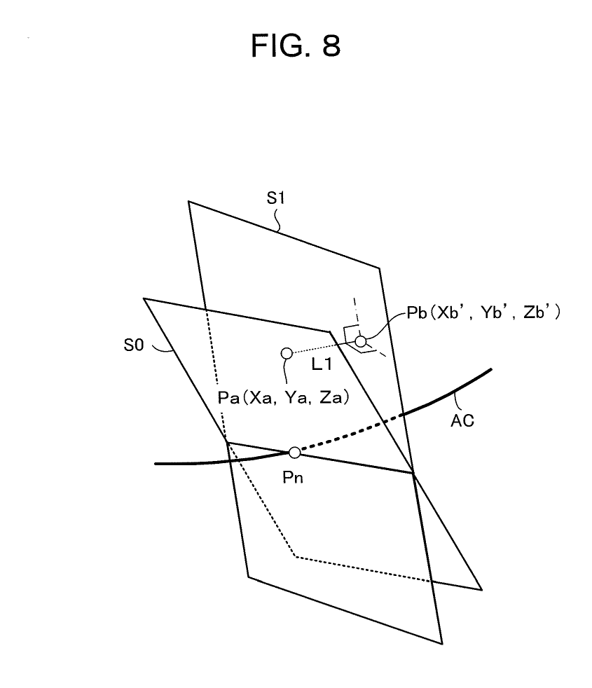

FIG. 8 schematically represents contents of the coordinate transformation. The position data on the irradiation plane S0 (shape data) is transformed into the shape data on the vertical plane S1 (coordinate transformation).

A point as a result of projecting a point Pa on the irradiation plane S0 onto the vertical plane S1, is set as a point Pb. The points Pa and Pb are represented by vectors Va(=[Xa, Ya, Za, 1]^{T}), and Vb(=[Xb′, Yb′, Zb′, 1]^{T}), respectively. The vectors Va and Vb are represented by the coordinates (Xa, Ya, Za) on the irradiation plane S0, and the coordinates (Xb′, Yb′, Zb′) on the vertical plane S1, respectively.

At this time, the vector Vb is calculated from the vector Va, in the following manner.

Vb=Cn′⁻¹·Cn·Va

As can be understood from the above description, the coordinate transformation based on “Cn′⁻¹·Cn” corresponds to the projection of the point on the irradiation plane S0 onto the vertical plane S1. By using this coordinate transformation, the position matrix Tn′ corresponding to the point on the corrected shape data is calculated (expression (3)). From a plurality of position matrixes Tn corresponding to the respective points on the shape data (points (coordinates) on the irradiation line LR), a plurality of position matrixes Tn′ corresponding to the respective points on the corrected shape data (points on the corrected irradiation line LR) are calculated.

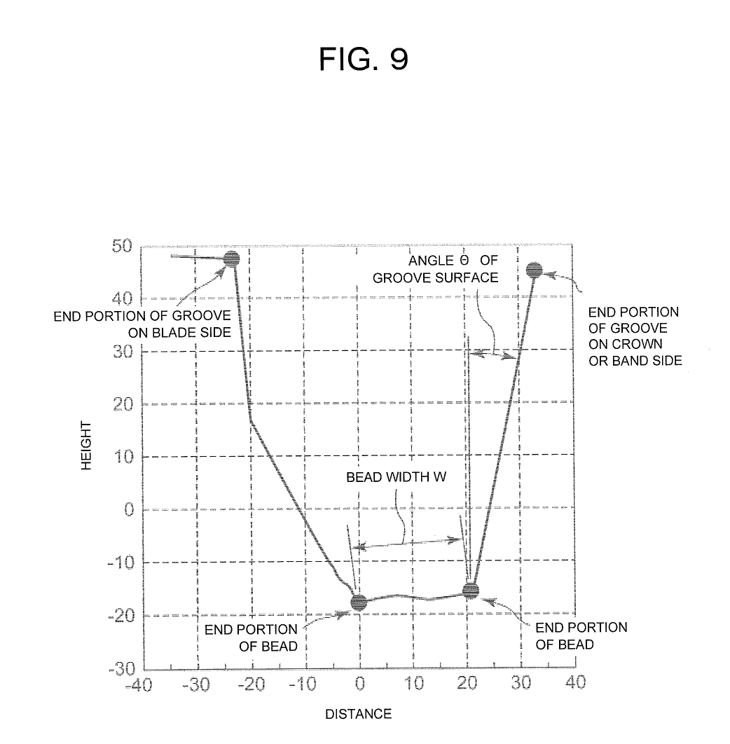

The corrected shape data (position matrix Tn′) is used in the point of change extraction process (step S6). Specifically, as illustrated in FIG. 9, a point with a large angular variation (angular difference) between vectors connecting the respective points on the shape data (points on the corrected irradiation line LR), is extracted as a point of change.

In the groove and bead surface extraction process (S7), processing as follows is performed. First, from the extracted points (points of change), two points to be end portions of the groove are extracted. Points existed between the two points are specified as end portions of the bead. From the positions of the end portion of the groove on the crown 19 side or the band 20 side and the end portion of the bead, an angle of the groove surface on the vertical plane S1 of the weld line, is calculated. Further, from a distance between the mutual endport ions of the bead, a bead width is calculated.

In the welding condition calculation process (step S8), processing as follows is conducted. First, from the angle of the groove surface on the vertical plane S1 of the weld line calculated in the groove and bead surface extraction process (step S7), and the transformation matrix Cn′ representing the position and the posture of the vertical plane S1 calculated in the coordinate transformation data calculation process (step S3), an inclination angle of the groove surface in the robot coordinate system is calculated. Based on the inclination angle of the groove and the gradient of the weld line, and the bead width calculated in the groove and bead surface extraction process (step S7), the welding conditions, and a target position and an optimum value for the torch posture on the vertical plane of the weld line, are determined. The welding conditions include a welding current, a welding voltage, a welding speed, a weaving frequency, a weaving amplitude, and a weaving direction.

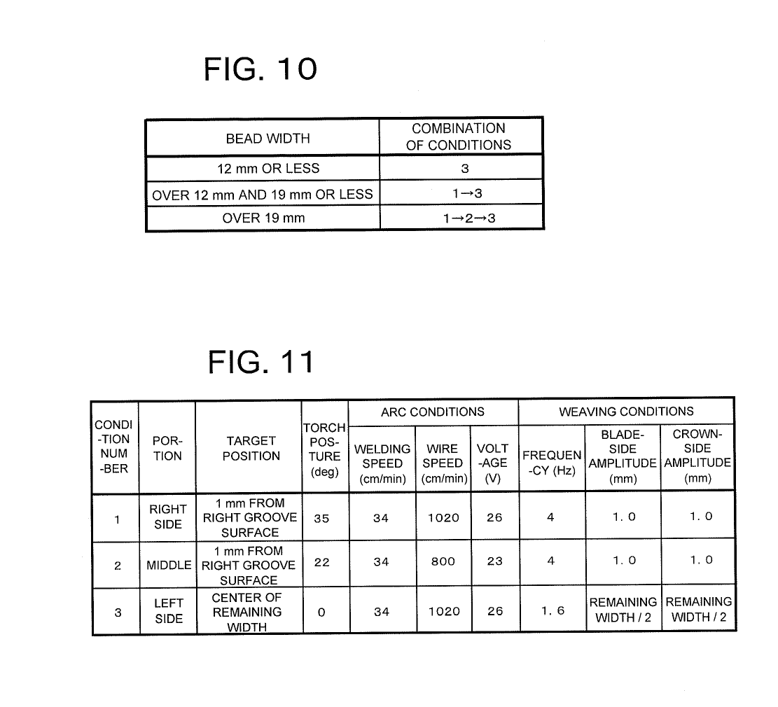

Concretely, conditional branch expressions are stored in the shape sensor processing device 6. FIG. 10 and FIG. 11 represent examples of the condition branch expressions. FIG. 10 represents a combination of conditions based on the bead width. FIG. 11 represents the welding conditions. Here, multilayer welding is taken into consideration.

If the bead width (a width of existing (lower layer) bead) is equal to or less than a first value (12 mm), a condition 3 is selected, resulting in that welding is performed in the middle of the existing bead, and a bead being an upper layer of the existing bead is formed. If the bead width is larger than the first value (12 mm), and is equal to or less than a second value (19 mm), conditions 1 and 3 are sequentially selected, resulting in that welding is performed at two portions being a portion on the right side and a portion on the left side. Further, if the bead width is larger than the second value (19 mm), the conditions 1, 2, and 3 are sequentially selected, resulting in that welding is performed at three portions being a portion on the right side, a center portion, and a portion on the left side.

The “end portion of previously formed bead” in the condition 2 in FIG. 11 means an end portion of the bead of a layer lower than a layer to be formed by welding.

In the conditions 1 to 3 illustrated in FIG. 11, the target position, the torch posture, and the welding conditions (arc conditions, weaving conditions) are set. As above, the target position, the torch posture, and the welding conditions in accordance with the bead width calculated in the groove and bead surface extraction process (step S7) are determined.

Here, in the conditional branch in FIG. 10 and FIG. 11, a range of gradient of the weld line to which the conditions 1 to 3 are applied is assumed to be set. Specifically, the conditional branch expressions as in FIG. 10 and FIG. 11 are assumed to be set for each gradient of the weld line. By configuring as above, if the bead width and the gradient of the weld line are determined, the target position, the torch posture, and the welding conditions are determined.

Note that the inclination angle of the groove is used as a reference of the torch posture. Specifically, the torch posture is determined by setting the groove surface as a reference face.

The target position, the torch posture, and the welding conditions described above are generally set as values on the vertical plane S1 of the groove. Accordingly, in the aforementioned expression (3), coordinates on the shape data are transformed into coordinates on the vertical plane S1.

Meanwhile, a transformation matrix Cn″ representing a position and a posture at the teaching point (the welding torch 3) of the welding teaching data is determined in the coordinate transformation data calculation process (step S3). This corresponds to the position and the posture of the tip of the arm of the welding robot 2, similar to the measurement teaching point, so that it can be represented by the following expression (4), similar to the expression (2).

Cn″=A₁·A₂·A₃·A₄·A₅·A₆ Expression (4)

Note that the contents of the matrix Aᵢ are not always the same in the expressions (1), (2), and (4) (the states of the arm of the welding robot 2 are different).

In the welding position and posture calculation process (S9), the calculated coordinate transformation matrix Cn″ is used to transform the target position and the torch posture on the vertical plane S1 of the weld line into the target position and the torch posture in the robot coordinate system. From a matrix Xd representing the position and the posture on the vertical plane S1 of the weld line, a matrix Xd′ represented by the robot coordinate system is calculated, in the following manner.

Xd′=Cn″⁻¹·Cn′·Xd

Here, the matrix Cn″ ⁻¹ represents an inverse matrix of the matrix Cn″.

Next, in the robot control device 5, the calculated welding position and posture, and the welding conditions are stored in the teaching data storage device 14.

By repeating the above operation for each shape measurement point, it is possible to teach the welding operation and to generate the welding teaching data. By automatically reproducing the teaching data, the welding operation is carried out.

From the above results, according to the present embodiment, by using the welding apparatus formed of the slider device 1, the welding robot 2, the welding torch 3, and the shape sensor 4, there is no need to provide a rail on which the welding robot is traveled.

Further, by using the robot control device 5 and the shape sensor processing device 6, a flexibility of the posture of the sensor that measures the weld bead shape is improved. As a result of this, it becomes possible to provide an automatic welding apparatus and welding method for a large and complicated structure, capable of performing high-quality automatic welding.

### Second Embodiment

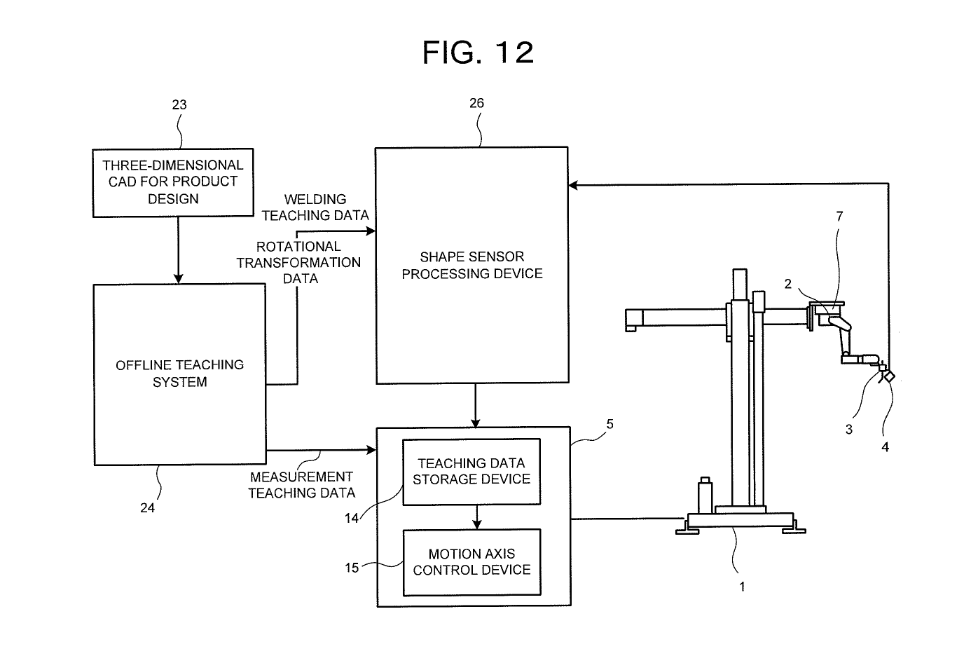

Next, a second embodiment will be described by using FIG. 12. Note that configurations same as those of the first embodiment are denoted by the same reference numerals, and overlapped explanation will be omitted.

As illustrated in FIG. 12, in the present embodiment, there are provided a three-dimensional CAD for product design 23 and an offline teaching system 24.

A welding apparatus of the second embodiment will be described using FIG. 12. This welding apparatus includes a slider device 1, a shape sensor processing device 26 that receives data from the slider device 1, and a robot control device 5 that transmits/receives data to/from the shape sensor processing device 26. The robot control device 5 includes a teaching data storage device 14 and a motion axis control device 15. The teaching data storage device 14 transmits measurement teaching data to the shape sensor processing device 26. The motion axis control device 15 controls operations of the slider device 1 and a welding robot 2.

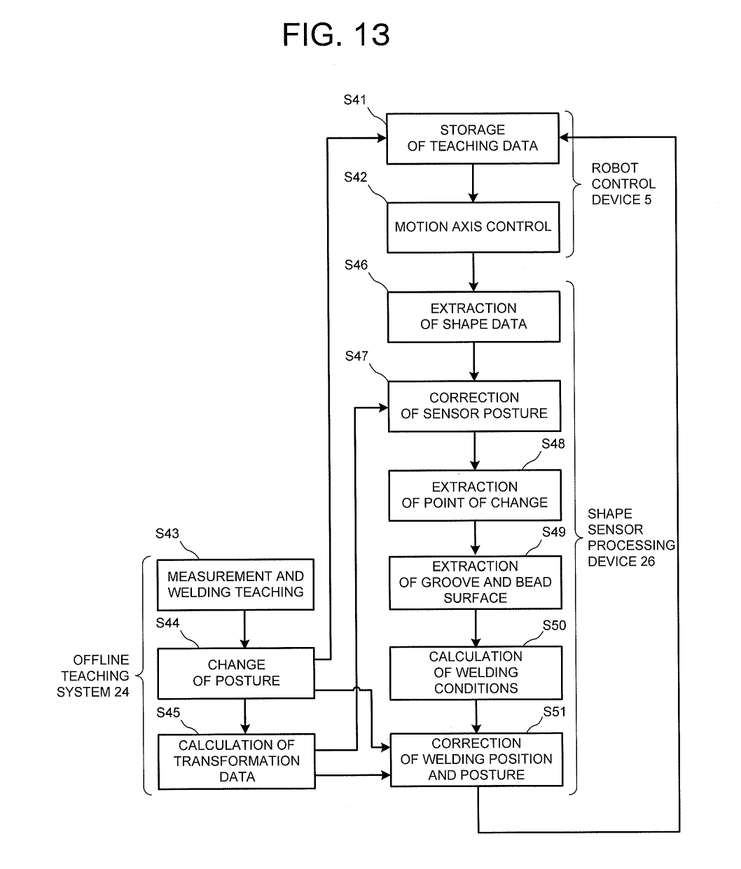

Description of the slide device 1 and the welding robot 2 will be omitted since it is overlapped with the description of the first embodiment. Data output from the shape sensor 4 is output to the shape sensor processing device 26. The shape sensor processing device 26 executes a process as illustrated in FIG. 13.

In a teaching data storage process (step S41), teaching data is stored in the teaching data storage device 14. For example, the teaching data is input by using an input device such as a keyboard.

In a motion axis control process (step S42), motion axes of the slider device 1 and the welding robot 2 are controlled, based on the teaching data (measurement teaching data) stored in the teaching data storage process (step S41).

The motion axis control device 15 drives the slider device 1 and the welding robot 2 to move the shape sensor to a measurement teaching point. Further, measured data from the shape sensor 4 is obtained.

In the offline teaching system 24, a measurement and welding teaching process (step S43), a posture changing process (step S44), and a transformation data calculation process (step S45) are executed.

In the measurement and welding teaching process (step S43), teaching data is created on a computer. In the posture changing process (step S44), an interference between an object of operation such as a large-sized hydraulic turbine runner and the welding apparatus is checked. If they interfere with each other, postures of the welding torch 3 and the shape sensor 4 are changed. In the transformation data calculation process (step S45), transformation data regarding the posture before changing the posture and the posture after changing the posture is calculated.

Meanwhile, in the shape sensor processing device 26, a shape data extraction process (S46), a sensor posture correction process (step S47), a point of change extraction process (step S48), a groove and bead surface extraction process (step S49), a welding condition calculation process (step S50), and a welding position and posture correction process (step 551) are executed. The welding position and posture correction process (step S51) is provided as a substitute for the welding position and posture calculation process (step S9) in the first embodiment.

Steps S46 to S51 correspond to step S4 to step S8 in the first embodiment, and indicate similar processes, respectively. Step S51 will be described later.

In the present embodiment, three-dimensional shape data of the object of operation such as the hydraulic turbine runner is created by using the three-dimensional CAD for product design 23, and is input into the offline teaching system 24, namely, a digitization device. In the first embodiment, a person operates the welding robot 2 to input the data. Specifically, the interference between the object to be welded and the welding apparatus is avoided by a person. On the contrary, in the present embodiment, the digitized data is input into the welding robot 2 by using the three-dimensional CAD for product design 23, and the offline teaching system 24. As a result of this, in the present embodiment, in the posture changing process (step S44), the interference is automatically avoided by using the three-dimensional data of the object to be welded and the welding apparatus.

In the measurement and welding teaching process (step S43), the input three-dimensional shape data of the object of operation is disposed on a virtual space on the computer, together with a previously created three-dimensional model of the welding apparatus (the slide device 1, the welding robot 2, the welding torch 3, and the shape sensor 4). Further, the teaching data is calculated so that the shape sensor (and the welding torch) is (are) disposed at a position and in a direction (posture) on a vertical plane S1 of a weld line of a groove portion of the object of operation represented by the three-dimensional shape data, and passing through a center of an angle between mutual groove surfaces.

Further, teaching data regarding an approach operation and a retreat operation with respect to the position and the posture, is added. By adding operation instructions to respective teaching points as above, measurement teaching data and welding teaching data are created.

Next, in the posture changing process (step S44), presence/absence of the interference between the object of operation and the welding apparatus is confirmed by using the above-described measurement and welding teaching data. If there is an interference, the postures of the welding torch 3 and the shape sensor 4 included in the teaching data are changed. The welding teaching data in which the postures are changed is used in the welding position and posture correction process (step S51). Further, the measurement teaching data is output to the teaching data storage device 14 and a transformation data calculation function 27.

In the transformation data calculation process (step S45), rotational transformation data from a state after changing the posture to a state before changing the posture, is calculated. For the calculation of the rotational transformation data, the posture data at the measurement teaching point in the measurement teaching data after changing the posture determined in the posture changing process (step S44), and posture data at the measurement teaching point in the measurement teaching data before changing the posture determined in the measurement and welding teaching process (step S43), are used.

In the sensor posture correction process (step S47), the shape data calculated in the shape data extraction process (step S46) is transformed based on the rotational transformation data, to thereby calculate shape data after correcting a distortion.

In the welding position and posture correction process (step S51), the position and posture data at the welding teaching point in the welding teaching data calculated in the posture changing process (step S44) is corrected. For the correction, the welding conditions, the target position and the torch posture on the vertical plane of the weld line calculated in the welding condition calculation process (step S50), and the rotational transformation data calculated in the above transformation data calculation process (step S45) are used.

The corrected position and posture data is stored in the teaching data storage device 14 as welding teaching data. In the robot control device 5, the motion axis control device 15 drives the slider device 1 and the welding robot 2 based on the welding teaching data stored in the teaching data storage device 14, to perform automatic welding.

From the above results, according to the present embodiment, by using the welding apparatus formed of the slider device 1, the welding robot 2, the welding torch 3, and the shape sensor 4, there is no need to provide a rail on which the welding robot is traveled.

Further, by using the robot control device 5, the shape sensor processing device 26, the three-dimensional CAD for product design 23, and the offline teaching system 24, a flexibility of the posture of the sensor that measures the weld bead shape is improved. As a result of this, it becomes possible to provide an automatic welding apparatus and welding method for a large and complicated structure, capable of performing high-quality automatic welding.

### Third Embodiment

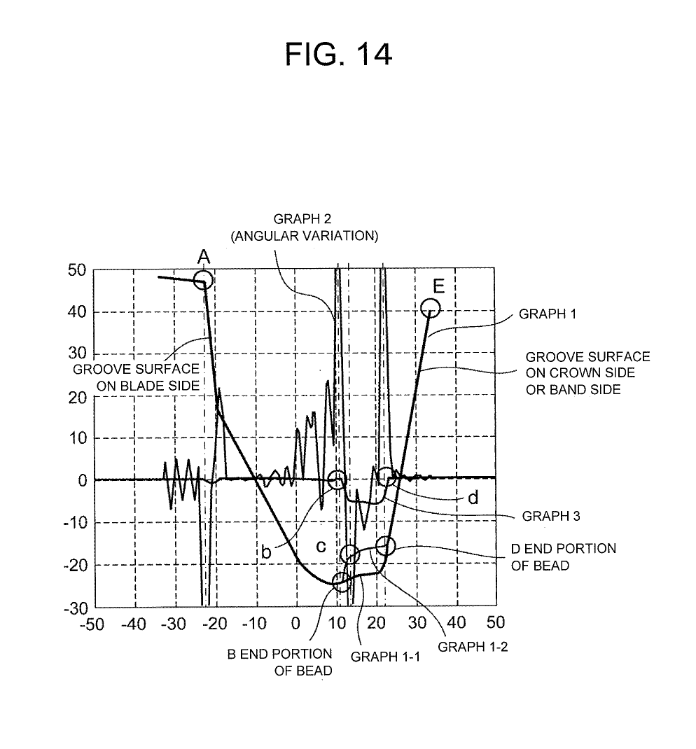

Next, a third embodiment will be described by using FIG. 14. Note that processes same as those of the first embodiment and the second embodiment are denoted by the same reference numerals, and overlapped explanation will be omitted.

Graphs 1, 1-1, 1-2, 2, and 3 illustrate shape data, previous shape data (indicating shape data at previous welding), shape data of this time (indicating a shape at welding of this time), an angular variation of vector of the shape data of this time, and a difference between the previous shape data and the shape data of this time, respectively. The shape data (graph 1) includes the previous shape data (graph 1-1) and the shape data of this time (graph 1-2).

In the present embodiment, in the point of change extraction process (steps S6, S48), four points A, B, C, and D each having a large angular variation of vector of the shape data, are extracted in a descending order of the variation. Regarding a portion to be a groove surface on a crown or a band side, an end portion E of the shape data is extracted as an end portion of the groove surface. Further, a difference between the previous shape data and the shape data of this time is calculated. Points B and D of the shape data of this time corresponding to points b and d each having a large variation of the difference, are extracted as end portions of the bead.

In the arc welding, the welding conditions, the target position, and the torch posture are selected so that the weld bead does not have an overlap shape which becomes a cause of incomplete penetration.

Further, in horizontal position of welding, a shape of lower end of the weld bead tends to have a gentle shape, compared with another welding position. In this case, when extracting the angular variation of the shape data, a phenomenon in which the end portions of the bead cannot be extracted, occurs.

In the present embodiment, the difference between the previous shape data and the shape data of this time is determined, and the points each having a large variation of the difference are extracted to be set as the end portions of the bead. In the welding condition calculation process (S8, S50), welding conditions including a welding current, a welding voltage, a welding speed, a weaving frequency, a weaving amplitude, and a weaving direction, and the target position and the torch posture on the measuring plane, corresponding to a bead width determined from the positions of the end portions of the bead, are determined.

From the above results, it is possible to securely determine the positions of the end portions of the bead from the measured shape data. By determining the welding conditions, the target position, and the torch posture based on this, it becomes possible to perform high-quality automatic welding.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A welding apparatus, comprising:
a welding torch and a shape sensor attached to a welding robot;
a shape data extraction unit extracting, from measured data measured by the shape sensor, shape data representing an outline of an object to be welded;
a transformation data calculation unit calculating, based on a position and a posture of the shape sensor, coordinate transformation data for correcting the shape data;
a shape data correction unit correcting the shape data based on the coordinate transformation data;
a point of change extraction unit extracting points of change in the corrected shape data;
a groove surface extraction unit extracting a groove surface based on the extracted points of change;
an angle calculation unit calculating an inclination angle of the extracted groove surface; and
a welding position and posture determination unit determining, based on a width of a bead, a position of the welding torch and a posture of the welding torch with respect to the inclination angle of the groove.

2. The welding apparatus according to claim 1, further comprising
a position and posture data generation unit generating, based on three-dimensional shape data of the object to be welded and the shape sensor, position and posture data representing a position and a posture of the shape sensor, which prevents an interference between the object to be welded and the shape sensor.

3. The welding apparatus according to claim 1,
wherein the shape sensor has an illumination device and an imaging device.

4. The welding apparatus according to claim 1, further comprising:
a slider device having a plurality of shafts; and
a control device controlling the slider device based on the determined welding position and posture,
wherein the welding robot is mounted on any one of the plurality of shafts.

5. A welding method, comprising:
controlling a position and a posture of a shape sensor with respect to an object to be welded, based on position and posture data;
extracting shape data representing an outline of the object to be welded, from measured data measured by the shape sensor whose position and posture are controlled based on the position and posture data;
calculating coordinate transformation data for correcting the shape data, based on the position and posture data;
correcting the shape data using the coordinate transformation data;
extracting a plurality of points of change in shape, from the corrected shape data;
extracting a plurality of points of change in shape corresponding to end portions of a bead, from the corrected shape data;
calculating a width of the bead and an inclination angle of a groove surface, based on the corrected shape data and the plurality of points of change in shape;
determining welding conditions, and a position of the welding torch and a posture of the welding torch with respect to the inclination angle of the groove surface, based on the width of the bead; and
performing welding based on the welding conditions, and the position and the posture of the welding torch.

6. The welding method according to claim 5, further comprising:
determining third position and posture data representing positions and postures of the shape sensor and the welding torch of the welding apparatus, on a vertical plane of a weld line and at an angle passing through a center of an angle between a pair of groove surfaces, by using three-dimensional shape data of the object to be welded;
confirming presence/absence of an interference between the welding apparatus and the object to be welded, when the shape sensor and the welding torch are disposed to correspond to the third position and posture data; and
determining, when the presence of the interference is confirmed, position and posture data representing positions and postures of the shape sensor and the welding torch, which prevents the interference between the welding apparatus and the object to be welded.

7. The welding apparatus according to claim 4, wherein
the plurality of shafts include a shaft in a first linear direction, a shaft in a second direction different from the first linear direction, and a rotation shaft.
